(19) United States
(12) Patent Application Publication
(10) Pub. No.: US 2006/0140740 A1
(43) Pub. Date: Jun. 29, 2006

(54) Screw with thread having different orientations

(76) Inventor: Teng-Hung Lin, Kaohsiung Hsien (TW)

Correspondence Address: TENG-HUNG LIN, 235 Chung-Ho, Box 8-24, Taipei, R.O.C., TW

(21) Appl. No.: 11/023,863

(22) Filed: Dec. 29, 2004

(51) Int. Cl. F16B 25/00

(52) U.S. Cl. 411/386

(57) ABSTRACT

A screw with thread having different orientations comprises a first thread extending to a tip of the screw; a second thread; a distal end of the second thread being formed with a cutting thread; a distal end of the first cutting thread being a cambered thread near the tip of the screw; a screwing angle of the cutting thread is larger than other portion of the second thread. Moreover, a distal end of the first thread is formed with a first cutting thread; a distal end of the first cutting thread being a cambered thread near the tip of the screw. A screwing angle of the first cutting thread is larger than other portion of the second thread. Furthermore, the screw may have only the second thread, but the first screw can be neglected.

### FIELD OF THE INVENTION

The present invention relates to screws and in particular to a screw with thread having different orientations, wherein by the design of the threads, the screw has a preferred positioning effect and can drill a hole easily.

### BACKGROUND OF THE INVENTION

Whether the operation of a screw is successful is mainly determined by the ability of removing the undesired odds. The design of the thread of a screw has a great effect to the ability of screw. The twisting force of the operation of the screw also affects the function of the screw. However, an exact fit between the screw to be inserted and the components to be fastened together is always needed. The length of the unthreaded shank portion between the underside of the screw head and the end of the thread functioning as a stop must be matched exactly to the thickness of the two components. For tolerance reasons, however, and also for reasons of various possible uses of such screws, no other screws can be used for each tenth graduation in thickness of components, and so such known solutions have only limited applicability.

In U.S. Pat. No. 6,254,326, “Screw having a tapered thread”, a screw for mutual fastening of two components provides a shank with a thread, an unthreaded shank portion and a screw head. The end region of the thread adjacent to the unthreaded shank portion tapers with constant thread pitch, and so the tapering end region of the thread forms a kind of frustoconical envelope surface upon rotation of the screw. During setting of the screw and during over-torquing thereof, the end region of the thread acts as a kind of milling cutter and makes a frustoconical opening in the component. The thread flights in the tapering end region can then be braced against the wall of this opening, so that mutual contact pressure between the components is possible despite over-torquing of the screw. The prior art has the disadvantages of bad positioning effect to the screw and having a high resisting force. Thus there is a demand for a novel design which can overcome the defect in the prior art.

### SUMMARY OF THE INVENTION

Accordingly, the primary object of the present invention is to provide a screw with thread having different orientations, wherein by the design of the threads, the screw has a preferred positioning effect and can drill a hole easily.

To achieve above objects, the present invention provides a screw with thread having different orientations. The comprises a first thread extending to a tip of the screw; a second thread; a distal end of the second thread being formed with a cutting thread; a distal end of the first cutting thread being a cambered thread near the tip of the screw; a screwing angle of the cutting thread is larger than other portion of the second thread. Moreover, a distal end of the first thread is formed with a first cutting thread; a distal end of the first cutting thread being a cambered thread near the tip of the screw. A screwing angle of the first cutting thread is larger than other portion of the second thread. Furthermore, the screw may have only the second thread, but the first screw can be neglected.

The various objects and advantages of the present invention will be more readily understood from the following detailed description when read in conjunction with the appended drawing.

### BRIEF DESCRIPTION OF THE DRAWINGS

FIG. 1 shows the first embodiment of the present invention.

FIG. 2 is an enlarged schematic view of FIG. 1.

FIG. 3 shows the second embodiment of the present invention.

FIG. 4 is an enlarged schematic view of FIG. 3.

FIG. 5 shows the third embodiment of the present invention.

FIG. 6 is an enlarged schematic view of FIG. 5.

FIG. 7 shows the fourth embodiment of the present invention.

FIG. 8 is an enlarged schematic view of FIG. 7.

FIG. 9 shows the fifth embodiment of the present invention.

FIG. 10 is an enlarged schematic view of FIG. 9.

FIG. 11 shows the sixth embodiment of the present invention.

FIG. 12 is an enlarged schematic view of FIG. 11.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

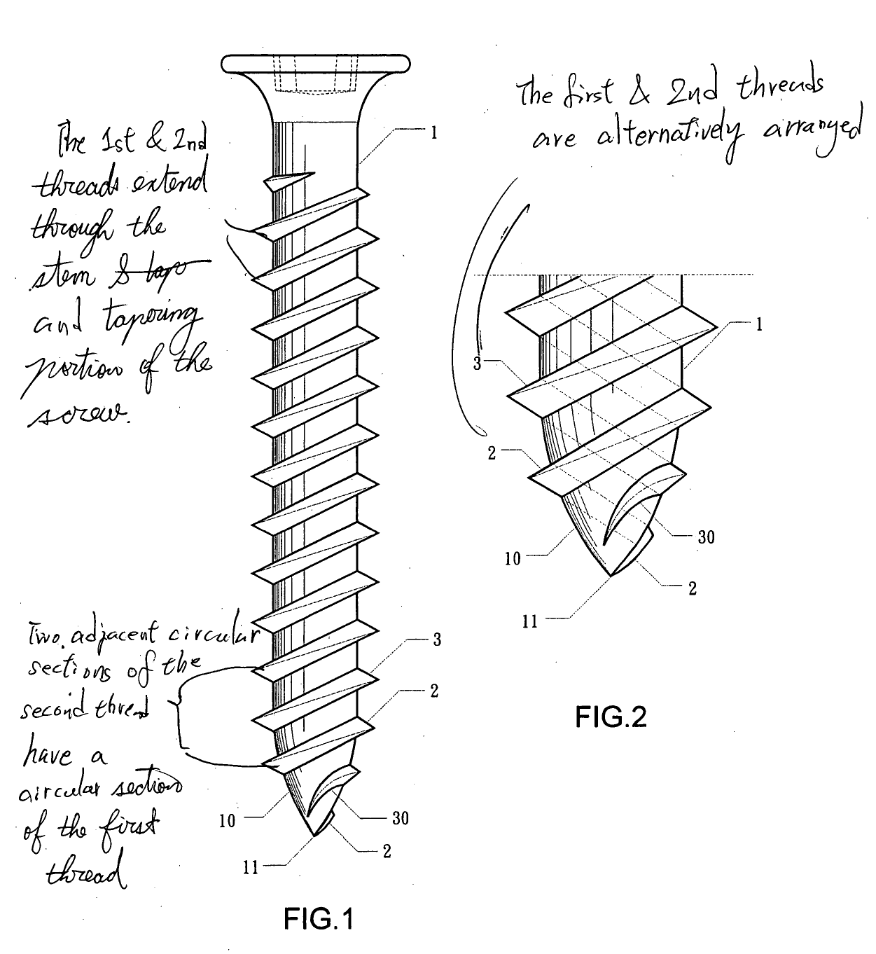

With reference to FIGS. 1 and 2, the screw with thread having different orientations of the present invention is illustrated. The present invention has the following elements.

A first thread 2 extends to a tip of the screw.

A second thread 3 is included. A distal end of the second thread 3 is formed with a cutting thread 30. A distal end of the first cutting thread 30 is a cambered thread near the tip 11 of the screw. A screwing angle of the cutting thread 30 is larger than other portion of the second thread 3.

Thereby the screw has a preferred positioning effect and can drill a hole easily.

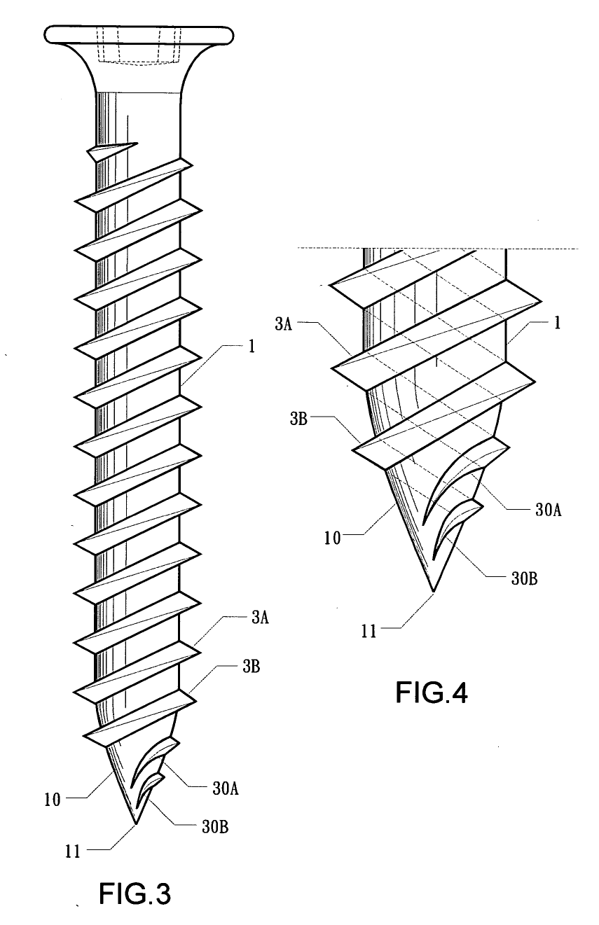

Referring to FIGS. 3 and 4, another embodiment of the present invention is illustrated. The present invention in this embodiment has the following elements.

A first thread 3A is included. A distal end of the first thread 3A is formed with a first cutting thread 30A. A distal end of the first cutting thread 30A is a cambered thread near the tip 11 of the screw, but not extend to the tip 11 of the screw. A screwing angle of the first cutting thread 30A is larger than other portion of the second thread 3A.

A second thread 3B is included. A distal end of the second thread 3B is formed with a second cutting thread 30B. A distal end of second cutting thread 30B is a cambered thread near the tip 11 of the screw, but not extend to the tip 11 of the screw. A screwing angle of the second cutting thread 30B is larger than other portion of the second thread 3B.

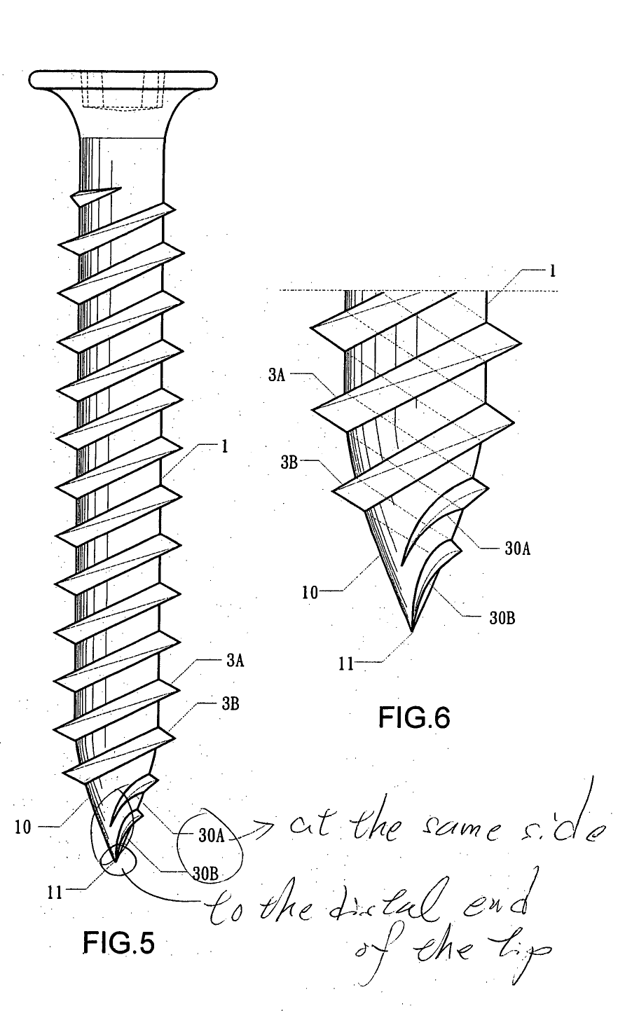

Referring to FIGS. 5 and 6, another embodiment of the present invention is illustrated. The present invention in this embodiment has the following elements.

A first thread 3A is included. A distal end of the first thread 3A is formed with a first cutting thread 30A. A distal end of the first cutting thread 30A is a cambered thread near the tip 11 of the screw, but not extend to the tip 11 of the screw. A screwing angle of the first cutting thread 30A is larger than other portion of the second thread 3A.

A second thread 3B is included. A distal end of the second thread 3B is formed with a second cutting thread 30B. A distal end of second cutting thread 30B is a cambered thread and is at the tip 11 of the screw. A screwing angle of the second cutting thread 30B is larger than other portion of the second thread 3B.

Thereby the screw has a preferred positioning effect and can drill a hole easily.

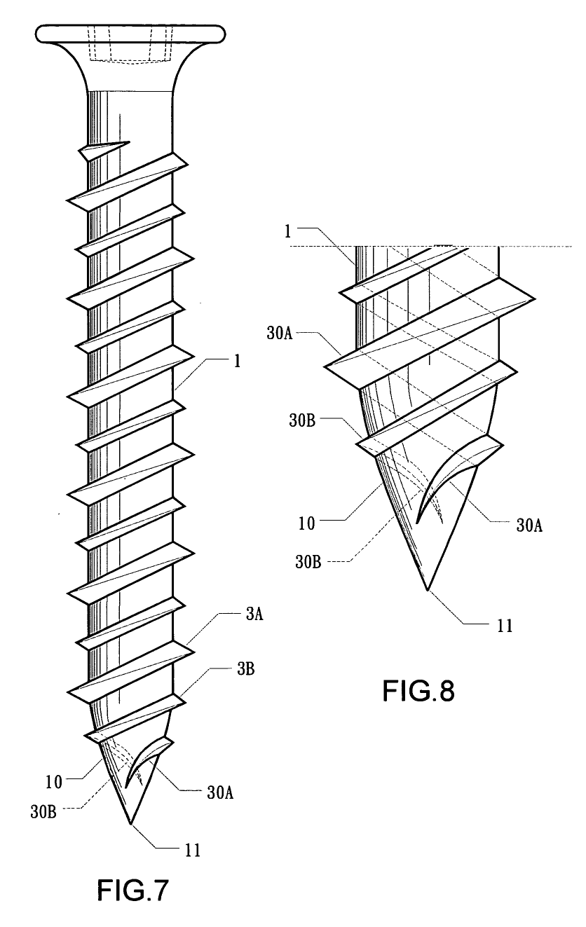

Referring to FIGS. 7 and 8, another embodiment of the present invention is illustrated. This the present invention is identical to that in FIGS. 5 and 6, but in FIGS. 5 and 6, the two cutting threads 30A and 30B are at the same side of the screw, while in FIGS. 7 and 8, the two cutting threads 30A and 30B are at opposite side.

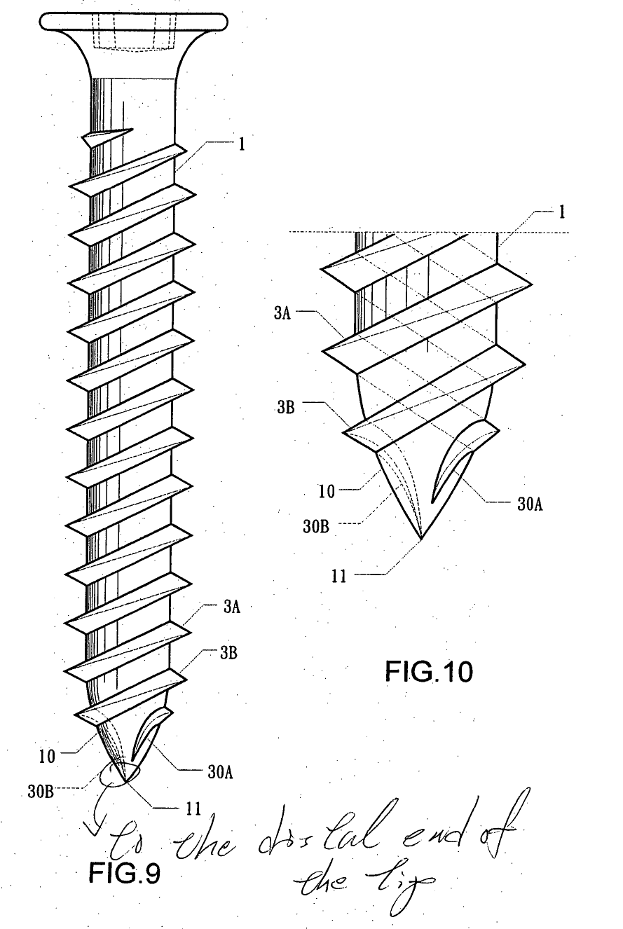

Referring to FIGS. 9 and 10, a embodiment like that in FIGS. 7 and 8 is illustrated, while in FIGS. 9 and 10, one cutting thread 30B extend to a tip of the screw.

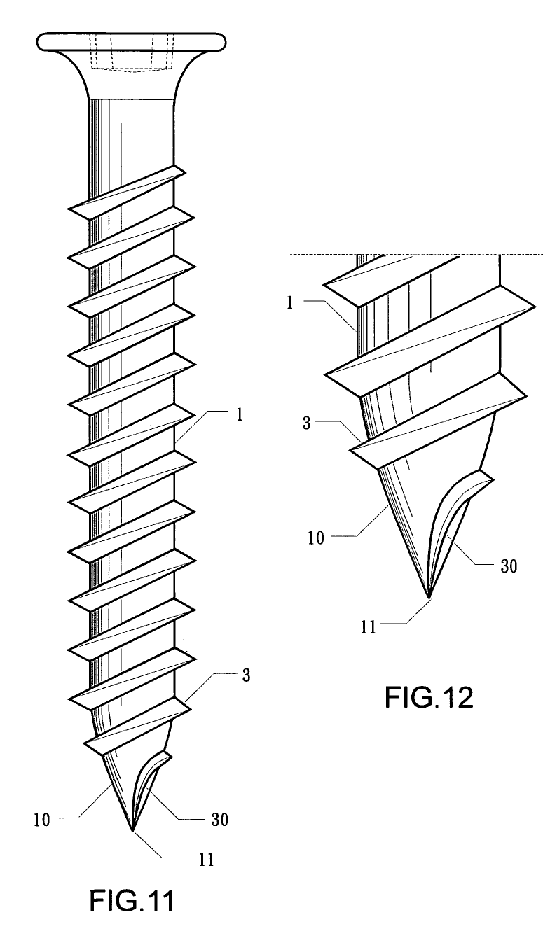

Referring to FIGS. 11 and 12, the screw with thread having different orientations of the present invention is illustrated. The present invention has the following elements.

A thread 3 is included. A distal end of the thread 3 is formed with a cutting thread 30. A distal end of the first cutting thread 30 is a cambered thread and is extended to the tip 11 of the screw. A screwing angle of the cutting thread 30 is larger than other portion of the second thread 3.

Thereby the screw has a preferred positioning effect and can drill a hole easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-11. (canceled)

12. A screw with threads having different orientations comprising:
a first thread; a distal end of the first thread being formed with a first cutting thread; a distal end of the first cutting thread being a cambered thread near a tip of the screw; a screwing angle of the first cutting thread being larger than other portion of the second thread;
a second thread; a distal end of the second thread being formed with a second cutting thread; a distal end of second cutting thread being a cambered thread near the tip of the screw; a screwing angle of the second cutting thread being larger than other portion of the second thread;
wherein the first and second threads are alternatively arranged; and between two adjacent circular sections of the second thread has a circular section of the first thread; and the first and second threads extend through a stem and tapering portion of the screw;
wherein one of the first and second cutting threads extended to a distal end of a tip of the screw; and
wherein a distal end of the first cutting thread and a distal end of the second cutting thread are at the same side of the screw.

13. A screw with threads having different orientations comprising:
a first thread; a distal end of the first thread being formed with a first cutting thread; a distal end of the first cutting thread being a cambered thread near a tip of the screw; a screwing angle of the first cutting thread being larger than other portion of the second thread;
a second thread; a distal end of the second thread being formed with a second cutting thread; a distal end of second cutting thread being a cambered thread near the tip of the screw; a screwing angle of the second cutting thread being larger than other portion of the second thread; and
wherein the first and second threads are alternatively arranged; and between two adjacent circular sections of the second thread has a circular section of the first thread; and the first and second threads extend through a stem and tapering portion of the screw; and
wherein the first cutting thread and second cutting thread are at opposite sides of the screw;
wherein one of the first and second cutting threads extends to a distal end of the tip of the screw and the other thread do not extend to the tip of the screw.
